(19) United States
(12) Patent Application Publication
(10) Pub. No.: US 2009/0206232 A1
(43) Pub. Date: Aug. 20, 2009

(54) MULTI-FUNCTIONAL BASE FOR MOUNTING A FLAT PANEL DISPLAY PRODUCT

(75) Inventor: Honghua Tan, Guangzhou Science City (CN)

Correspondence Address: BANNER & WITCOFF, LTD., TEN SOUTH WACKER DRIVE, SUITE 3000, CHICAGO, IL, 60606, US

(73) Assignee: Guangzhou Echom Science & Technology Group Co., Ltd., Guangzhou City (CN)

(21) Appl. No.: 12/101,176

(22) Filed: Apr. 11, 2008

(30) Foreign Application Priority Data
Feb. 18, 2008 (CN) 200820044062.2

(51) Int. Cl. F16M 11/04

(52) U.S. Cl. 248/688; 248/176.3

(57) ABSTRACT

A multi-functional base for mounting a flat panel display product, comprising: a bottom plate suitable for being placed on a work table, a mounting plate for holding the flat panel display product, and an upright post between the bottom plate and the mounting plate, wherein the upright post comprises a lower upright post connected to the bottom plate and an upper upright post connected to the mounting plate, and a slide lifting device is mounted between the lower upright post and the upper upright post. The base according to the present invention is ergonomic and convenient for use.

### BACKGROUND OF THE INVENTION

The present invention relates to an auxiliary device for flat panel display product, and in particular to a multi-functional base for mounting flat panel display product.

Among the known display products, the flat panel display product such as flat panel display and flat panel TV become the main trend. However, only the elevation angle of the base of the known flat panel display product can be adjusted, which does not cater to the requirement of different users with different habit or height. Moreover, for a wide flat panel display product, it can not be adjusted into vertical direction, that is, it is not suitable for displaying the document or image vertically. Thus, it is desired to overcome the above-mentioned problems of the base for mounting the flat display product.

### SUMMARY OF THE INVENTION

It is an object of the present invention to provide a multi-functional base for mounting a flat panel display product. After the flat panel display product is mounted on the base, the height position of flat panel display product may be set conveniently.

To fulfill the above object, a multi-functional base for mounting a flat panel display product comprises a bottom plate suitable for being placed on a work table, a mounting plate for holding the flat panel display product, and an upright post between the bottom plate and the mounting plate, wherein the upright post comprises a lower upright post connected to the bottom plate and an upper upright post connected to the mounting plate, and a slide lifting device is mounted between the lower upright post and the upper upright post.

When in use, a flat panel display is mounted on the mounting plate and then placed on a work table such as a table top, and the upper upright post is allowed to slide with respect to the lower upright post and stop at any position desired. Thus, the height position of the flat panel display could be adjusted according to the requirement of the user.

Preferably, slide guideways are provided between the upper upright post and the lower upright post. The height adjustment of the upright post may be obtained through a slider sliding in the guideway. The slide guideways may be provided with a rolling element such as a ball or a roller therebetween. The slide guideway is to provide a smoother sliding movement between the upper upright post and the lower upright post, and reduce the possible shaking.

Preferably, a height setting device is provided between the upper upright post and the lower uptight post. The height setting device may be a damping regulator which consists of a regulating screw, a compression spring and a friction element. A constant force coil spring is fixed to the lower upright post at the upper end, and to the upper upright post at the lower end. The regulating screw is mounted on either the upper upright post or the lower upright post, and the front end of the regulating screw presses against the opposite lower upright post or upper upright post through the compression spring and the friction element. The structure of the constant for coil spring is similar to the clockwork spring in a clock. The pressure between the friction element and the upper upright post or the lower upright post can be adjusted by the regulating screw, and thus the friction force between the upper upright post and the lower upright post is adjusted. After the flat panel display product is mounted on the base, the weight of the upper upright post, the weight of the mounting plate, the weight of the flat panel display product, the pulling force of the coil spring, and the friction force generated by the damping regulator reach a balance, and thus the flat panel display product can hold still at any position required. Though different flat panel display product has different weight, it can be regulated by adjusting the dimension of the coil spring and the damping magnitude of the damping regulator.

Preferably, the mounting plate is connected to the upper end of the upright post by a shaft, and a damping spring surrounds the shaft and is mounted on the mounting plate. When the mounting plate rotates around the shaft, the elevation angle of the flat panel display product can be thus regulated. The damping spring is to increase the resistance during the rotation of the mounting plate.

Preferably, the mounting plate comprises a rotatable seat and a rotatable plate. The rotatable seat is connected to the upright post. The rotatable plate is connected to the rotatable seat by a shaft, and can rotate around the rotatable plate. The rotatable plate is provided with holes for mounting the flat panel display product. After the flat panel display product is mounted on the rotatable plate, it can rotate with respect to the rotatable plate. Thus, the wide flat panel display product can be set to display in vertical direction, to allow the display of vertical image or document more conveniently.

The bottom plate comprises a lower bottom plate and an upper bottom plate. The lower bottom plate is for contacting with the work table, while the upper bottom plate is rotatably mounted on the lower bottom plate. The horizontal angle of the flat panel display product can be adjusted by rotating the upper bottom plate with respect to the lower bottom plate. To avoid the upper bottom plate being rotated without consciousness, a friction damping element may be provided between the upper bottom plate and the lower bottom plate.

### BRIEF DESCRIPTION OF THE DRAWINGS

FIG. 1 is a perspective view of the base according to an embodiment of the present invention;

FIG. 2 is a structural view of the base, removing the housing of the upper upright post and the lower upright post;

FIG. 3 is an enlarged view of the upper portion of the base shown in FIG. 2, removing the housing of the rotatable seat and the rotatable plate;

FIG. 4 is a sectional view of the base shown in FIG. 2, taking along the line A-A;

FIG. 5 is a structural view of the slide lifting device between the upper upright post and the lower upright post;

FIG. 6 is a lateral sectional view of the upper upright post and the lower upright post;

FIG. 7 is a structural view of the mounting plate;

FIG. 8 is an exploded view of the bottom plate.

Reference Numerals: 1 bottom plate; 2 mounting plate; 3 upper upright post; 4 lower upright post; 5 slide guideway; 6 rolling element; 7 constant force coil spring; 8 shaft; 9 damping spring; 10 rotatable seat; 11 rotatable plate; 12 lower bottom plate; 13 upper bottom plate; 14 friction damping piece; 15 mounting hole; 16 shaft; 17 regulating screw; 18 compression spring; 19 friction element.

### DETAILED DESCRIPTION OF THE INVENTION

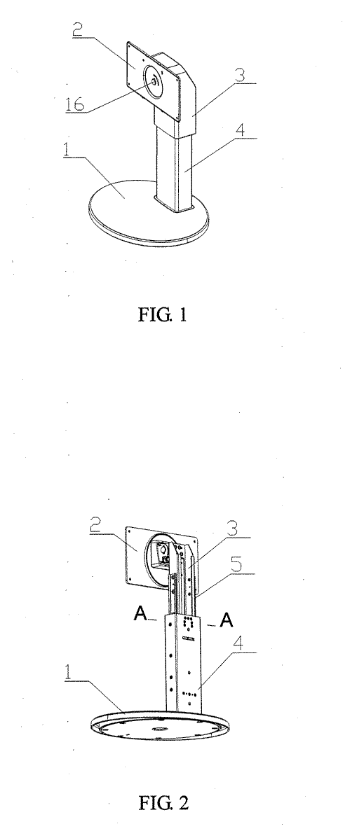

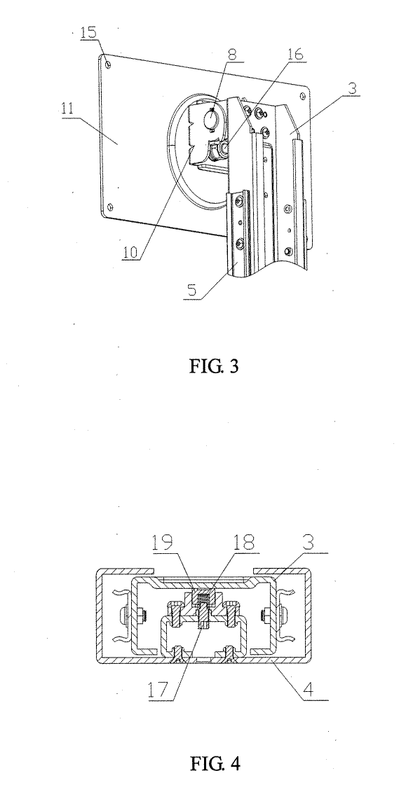

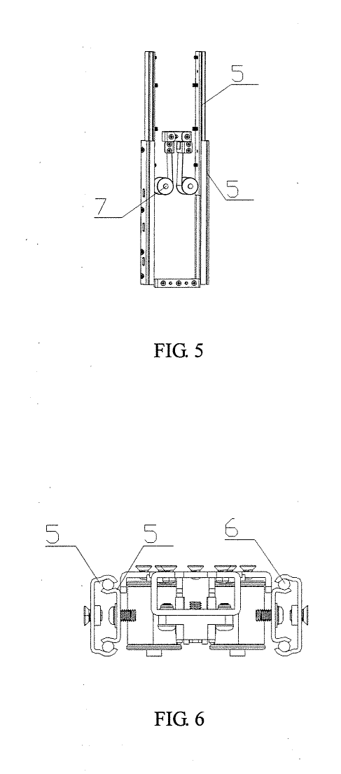

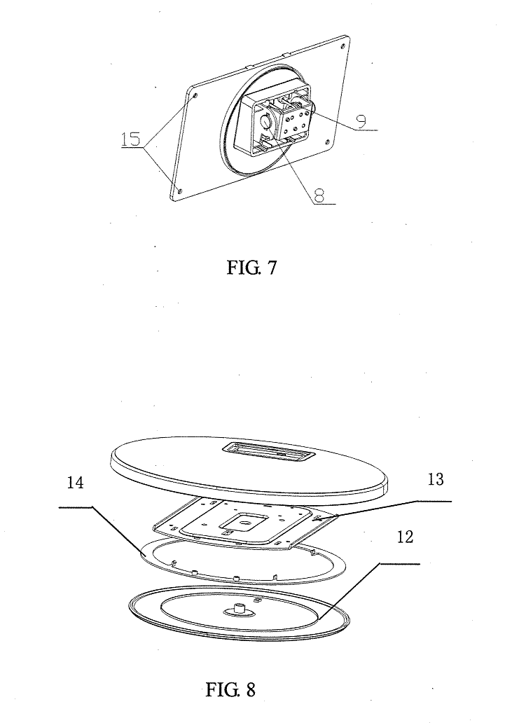

Referring to FIG. 1 to FIG. 8, a multi-functional base for mounting a flat panel display product comprises a bottom plate 1 suitable for being placed on a work table, a mounting plate 2 for holding the flat panel display product, and an upright post between the bottom plate 1 and the mounting plate 2, wherein the upright post comprises a lower upright post 4 connected to the bottom plate 1 and an upper upright post 3 connected to the mounting plate 2, and a slide lifting device mounted between the lower upright post 4 and the upper upright post 3.

In particular, slide guideways 5 are provided between the upper upright post 3 and the lower upright post 4. The slide lifting device is the slide guideways 5. The slide guideways 5 are provided with a rolling element 6 therebetween. A constant force coil spring 7 and a damping regulator are also provided between the upper upright post 3 and the lower upright post 4. The damping regulator consists of a regulating screw 17, a compression spring 18 and a friction element 19. The constant force coil spring 7 is fixed to the lower upright post 4 at the upper end, and to the upper upright post 3 at the lower end. The regulating screw 17 is mounted on the lower upright post 4, and the front end of the regulating screw 17 presses against the upper upright post 3 through the compression spring 18 and the friction element 19. The mounting plate 2 comprises a rotatable seat 10 and a rotatable plate 11. The rotatable seat 10 is connected to the upper end of the upright post 3 by a shaft 8. The damping spring 9 surrounds the shaft 8 and is mounted on the rotatable seat 10. The rotatable plate 11 is rotatably connected to the rotatable seat 10 by a shaft 16. The rotatable plate 11 is provided with holes 15 for mounting the flat panel display product. The bottom plate 11 comprises a lower bottom plate 12 and an upper bottom plate 13 (a metal plate). The lower bottom plate 12 is for contacting with the work table, while the upper bottom plate 13 is rotatably mounted on the lower bottom plate 12. A friction damping element 14 is provided between the upper bottom plate 13 and the lower bottom plate 12.

With the base according to the present invention, the horizontal angle, elevation angle and height position of the flat panel display product can be adjusted freely according to the particular situations such as user's habit, user's height, the height of chair, etc. Furthermore, the wide flat panel display product can be adjusted to display vertically. The base according to the present invention is ergonomic and convenient for use.

What is claimed is:

1. A multi-functional base for mounting a flat panel display product, comprising:
a bottom plate suitable for being placed on a work table;
a mounting plate for holding the flat panel display product;
an upright post between the bottom plate and the mounting plate;
wherein the upright post comprises a lower upright post connected to the bottom plate and an upper upright post connected to the mounting plate, and a slide lifting device is mounted between the lower upright post and the upper upright post.

2. The base of claim 1, wherein slide guideways are provided between the upper upright post and the lower upright post, the slide lifting device is the slide guideways.

3. The base of claim 2, wherein a rolling element is provided between the guideways of the upper upright post and the lower upright post.

4. The base of claim 1, wherein a height setting device is provided between the upper upright post and the lower upright post.

5. The base of claim 4, wherein the height setting device is a constant force coil spring with the lower end fixed on the upper upright post and the upper end fixed on the lower upright post.

6. The base of claim 4, wherein the height setting device comprises a regulating screw, a compression spring and a friction element, the regulating screw is mounted on either the upper upright post or the lower upright post, and the front end of the regulating screw presses against the opposite lower upright post or upper upright post through the compression spring and the friction element.

7. The base of claim 1, wherein the mounting plate is connected to the upper end of the upright post by a shaft, and a damping spring surrounds the shaft and is mounted on the mounting plate.

8. The base of claim 1, wherein the mounting plate comprises a rotatable seat and a rotatable plate, the rotatable seat is connected to the upright post, the rotatable plate is rotatably connected to the rotatable seat by a shaft, the rotatable plate is provided with holes for mounting the flat panel display product.

9. The base of claim 1, wherein the bottom plate comprises a lower bottom plate for contacting with the work table and an upper bottom plate rotatably mounted on the lower bottom plate.

10. The base of claim 9, wherein a friction damping element is provided between the upper bottom plate and the lower bottom plate.
